(19) United States
(12) Patent Application Publication
(10) Pub. No.: US 2018/0056181 A1
(43) Pub. Date: Mar. 1, 2018

(54) SYSTEM AND METHOD FOR DATA INTEGRATION FOR A VIRTUAL ENVIRONMENT

(71) Applicant: icejam games inc., Charlottetown (CA)

(72) Inventors: Stuart DUNCAN, Charlottetown (CA); Wayne SEIFRIED, Charlottetown (CA)

(21) Appl. No.: 15/681,594

(22) Filed: Aug. 21, 2017

Related U.S. Application Data
(60) Provisional application No. 62/378,991, filed on Aug. 24, 2016.

(51) Int. Cl. A63F 13/327

(52) U.S. Cl. CPC A63F 13/327; A63F 2300/407; A63F 2300/69

(57) ABSTRACT

A system for data integration for a virtual environment, the system including: a game backend; a plurality of game clients, wherein each of the game clients comprise a client engine which is connected to the game backend; a plurality of data sources; and a data engine connected with the game backend and with the plurality of data sources, wherein the data engine retrieves data from the data sources and provides it to the game backend for use by the game clients, via the client engine. A method for data integration for a virtual environment, the method including: receiving a data request from a game client; retrieving data from a data source that complies with the data request or, if data is not available from the data source, synthesizing data; transforming the retrieved data into a format usable by the game client; and transmitting the data to the game client.

### RELATED APPLICATIONS

This is a formal application based on and claiming the benefit of U.S. Provisional Application No. 62/378,991, filed Aug. 24, 2016, which is hereby incorporated herein by reference.

### FIELD

This disclosure relates to the integration of real world data into a virtual environment and, in particular, to the use of real world data in a gaming environment.

### BACKGROUND

In recent years there has been an ever increasing effort to collect various types of data and, in at least some cases, make it available either freely or at a cost. For example, data is collected on weather (including temperature, weather patterns, likelihood of precipitation, levels of precipitation, winds, and the like), sports statistics, website traffic, cell phone movement, app usage, physical activity and much more. Some of the data is publicly available and other data is kept either private or semi-private.

There has also been some movement toward using the available data in various ways. For example, weather and map/traffic information is quite available on the Internet. Some applications are also making use of what is sometimes referred to as dynamic data. For example, dynamic maps can provide increased utility and relevance to various mobile applications (example, Uber™). While some progress has been made at integrating data into specialized applications, there are considerable challenges to transforming informational data into usable data that is relevant, reliable, and scalable enough for various other types of applications, including computer games and mobile games.

As such, there is a need for an improved system and method for providing real world data in virtual environments that overcomes or mitigates at least one disadvantage of previous systems and methods.

### SUMMARY

The present disclosure describes embodiments of an improved system and method for data integration for a virtual environment that is intended to overcome at least some of the issues with conventional systems and methods.

According to an aspect herein, there is provided a system for data integration for a virtual environment, the system including: a game backend; a plurality of game clients, wherein each of the game clients comprise a client engine which is connected to the game backend; a plurality of data sources; and a data engine connected with the game backend and with the plurality of data sources, wherein the data engine retrieves data from the data sources and provides it to the game backend for use by the plurality of game clients, via the client engine.

With this system, a game client can request various types of data, the data engine retrieves and prepares the data for the game client and the game client can use the data in various ways within the gaming environment.

In a particular case, the data engine may include a data collector for retrieving the data from the data sources and a request handler for handling data requests from the game backend. In another case, the data engine may include or also include a data generator for generating simulated data when the requested data is not available or is temporarily suspended or the like.

According to an aspect herein, there is provided a method for data integration for a virtual environment, the method including: receiving, at a data engine, a data request from a game client via a game backend; retrieving data from a data source that complies with the data request or, if data is not available from the data source, synthesizing data; transforming the retrieved data into a format that is usable by the game client requesting the data; transmitting the data to the game client via the game backend.

### BRIEF DESCRIPTION OF THE DRAWINGS

Embodiments of the disclosure will now be described, by way of example only, with reference to the attached drawings, in which:

FIG. 1 is a block diagram of a system for data integration according to an embodiment herein; and

FIG. 2 is a flowchart of a method of data engine operation according to an embodiment herein.

### DETAILED DESCRIPTION

In the following description, various embodiments of the present disclosure will be described. For purposes of explanation, specific configurations and details are set forth in order to provide a thorough understanding of the embodiments. However, it will also be apparent to one skilled in the art that the present disclosure may be practiced without the specific details. Furthermore, well-known features may be omitted or simplified in order not to obscure the embodiment being described.

The present description provides embodiments of a system and method that gathers data from the real world and then processes and stores the real world data to be used in gameplay in virtual worlds, such as, computer games, or other similar applications. The real world data that the system gathers can be extremely diverse, ranging from the extremely fast moving and ephemeral, such as twitter, to slow moving data that exists not only in the past and present, but holds information about the future too, such as weather.

The disclosure is directed at a method and system for providing data with regard to playing games on a game client. The method includes receiving a request from a game client for game playing data and then retrieving the requested data before providing this data to the game client. The information may be retrieved from data sources, a data store or may be synthesized by the system.

In one embodiment, the system includes a data engine which communicates with the game client to receive the data request and may communicate with data sources to retrieve the requested data.

The disclosure will typically rely on many data sources to drive one output to provide game clients access to various types of useful data that may be available to them. In some cases, data can also be synthesized, in the case of data that doesn't exist, is temporarily unavailable, or for simulation purposes. In one embodiment, the data relates to real world weather and time of day data for a virtual (game) world.

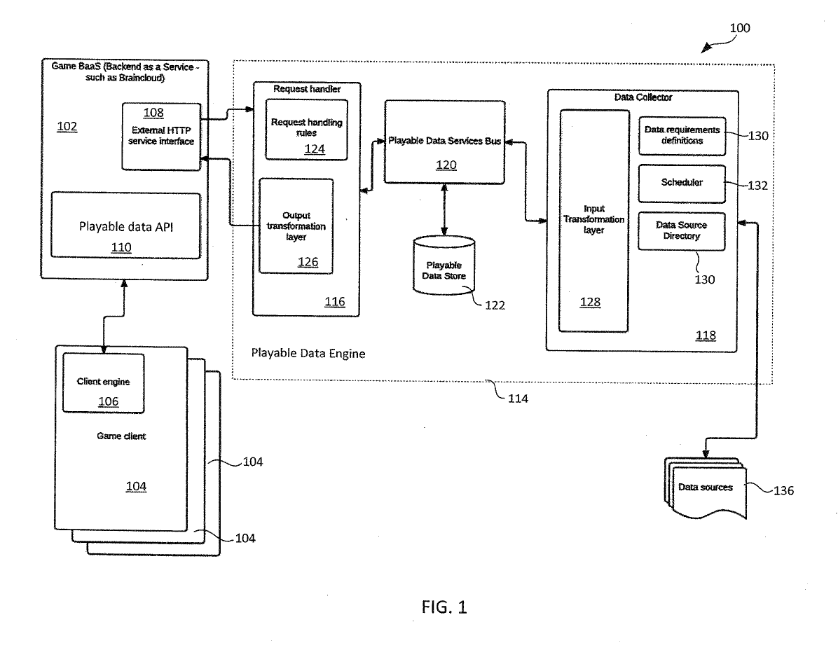

As shown in FIG. 1, an embodiment of the system 100 includes various components and at least one processor that executes computer readable instructions to partially or fully implement the functionality of the various components. The system 100 includes a game backend 102 and a set of game clients 104, each of the game clients 104 including a client engine 106 which is connected to the game backend 102. The game backend 102 includes an interface 108, such as an external HTTP service interface, and a data application programming interface (API) 110.

The system 100 further includes a data engine 114 (or playable data engine) which includes a request handler 116 and a data collector 118. The data engine 114 preferably includes server side components of the system 100. The request handler 116 and the data collector 118 are connected via a data service bus 120. A data store 122 is also connected to the request handler 116 and the data collector 118 via the data service bus 120. The data service bus 120 co-ordinates data traffic between the request handler 116, data collector 118, and data store 122.

The request handler 116 includes a request handling rules apparatus 124 and an output transformation layer 126. The game backend 102 is connected to the request handler 116 via the interface 108.

The data collector 118 includes an input transformation layer 128 along with a data requirements definitions apparatus 130, a scheduler 132 and a data source directory 134. A set of data sources 136 is connected to the data collector 118.

In one embodiment, the data collector 118, or data collector module, collects data from the data sources 136 to generate playable data for the game clients 104. The data is processed and then stored in the data store 122. This data may then be retrieved, when required, by the request handler 116 via the data services bus 120.

The data source directory 134 defines, and stores information about the data sources 136 and their properties, such as, but not limited to, type of data available, the URL or source address, rate limit or is the data real or synthesized.

The data requirements definitions apparatus 130 defines, and stores data to be acquired and stored from the data sources 136. The data requirements definitions apparatus 130 also defines, or determines, what data to retrieve, and when, from the data sources 136. For example, if the data collector 118 knows that there's going to be regular requests for data associated with weather in a certain location, the definitions apparatus 130 determines which data source 136 to acquire the weather data from and how to store this weather data within the data store 122.

The scheduler 132 manages polled data fetches. The scheduler 132 also drives the data collector 118 when data requirements dictate that a data source 136 should be monitored and mined regularly for data rather than just in response to an individual request. The input transformation layer 128 receives incoming data retrieved from the data sources 136 and transforms it to a general data format. For example, the transform could be simple, such as storing the current weather of a specific geographical location in the data store 122, or it could be more complex, such as acquiring a number of tweets and turning them into one useful piece of data.

The data store 122 is preferably a database where event data is stored by the data collector 118 and retrieved by the request handler 116. Existing data in the data store 122 may be re-used to respond to game client requests whenever possible, to reduce traffic between the data collector 118 to the external data sources 136.

The request handler 116 receives incoming requests from game clients 104 (via the game backend 102) and retrieves or fetches the relevant data associated with the request from the data store 122. The request handler 116 then transforms the retrieved data to suit the requirements of the requesting game client 104. The transformed data is then transmitted back to the requesting game client 104 via the game backend 102.

If the data for a given request is not available in the data store 122, the request handler 116 transmits a request to the data collector 118 via the data services bus 120 to fetch the data (from one of the data sources 136) to fulfil the request. The data received from the data source 136 is then transformed accordingly before being transmitted to the requesting game client 104.

The request handling rules apparatus 124 defines how to handle incoming requests from game clients 104. The request handling rules apparatus 124 determines the type of data that is needed to fulfil the request. For example, if a particular game client 104 provides an incoming request relating to how much rain is falling at a particular geographic location, the rules for handling this request specifies the type of data to fetch from the data store 122, with fallback options in case the data isn't immediately available. If live rainfall data isn't currently stored, previous data, such as the weather forecast from the previous day could be substituted and/or a message sent to the data collector 118 to fetch this data.

The output transformation layer 126 transforms the data received from either the data store 122 or the data collector 118 in response to the request from the game client 104. In one embodiment, the output transformation layer 126 converts the data into a form required to fulfil the request. For example, a request may require three different pieces of information packaged into a JavaScript Object Notation (JSON) object in a specified way.

The game client 104 may be any game (or application) that is configured to use the data engine 114 (typically this means it is configured with the client engine 106). The game client 104 may be executed on a mobile device, such as, but not limited to, a smartphone, a tablet, a laptop and the like.

In one embodiment, the game is a mobile free-to-play game developed with, for example, the Unity game engine. In this embodiment, game clients 104 connect to the data engine 114 via the client engine 106. The client engine 106 represents a client API for connection to the API 110 in the game backend 102. The client engine 106 is preferably built within the Unity game project and interfaces with the API 110 in the game backend 102 to transmit data requests and receive the data from the data engine 114.

The game backend 102 may be, for example, a service provided by a third party that provides mobile games with online services such as user management, push notifications, and integration with social networking services. It may also provide access to cloud storage and execute server side game logic. The game backend 102 may be configured as a single point of communication between a game client 104 and all other services including, but not limited to, the data engine 114. The game client 104 and any game specific server side code may access the data engine 114 via the game backend 102.

The external HTTP service interface 118 provides access to HTTP services from within the game backend 102 and provides an API for server side game code to communicate with the data engine 114 to send requests from game clients 104 and to receive data from the data engine 114. The interface 118 may also provide functionality for server side game code, for example, to listen to incoming requests from external parties and respond to them. For example, event notifications that are sent from the data engine 114 to the game backend 102.

In some embodiments, the data API 110 is a general purpose API for use on the game backend 102. Game clients 104 and server side game specific logic for each game can use this API 110 to request and consume playable data from the data engine 114.

In one aspect, there is provided a method and apparatus for constructing a data engine client and server platform that supports the collection, storage, and real-time retrieval of data for the use in playing a game.

In a general embodiment, the apparatus includes a server platform (or data engine) including an infrastructure (which may be, for example, cloud based) provided and maintained by third parties, such as, but not limited to, Amazon™, Heroku™, Rackspace™ or Softlayer™. In some embodiments, the server platform executes code that is able to be scaled both up and down cleanly. In one embodiment, the server platform may be required to handle a peak load of 3000 queries per second from game clients and 1500 requests per second to external data sources on the data collector side. It is preferred that the server platform include a structure which is capable of handling the intensity of the loads that the data engine will have to accommodate. In another embodiment, the data engine 114 may support both local and cloud based architecture.

In some embodiments, the server platform or data engine is a highly scalable, event driven architecture reducing or minimizing concurrency. Languages such as Assess Node.js, Ruby and Python are generally suitable languages for programming the server platform.

With respect to the data collector 118, one of the functions of the data collector 118 is to fetch data from diverse data sources 136. These data sources 136 can include live, historical, and forecast data services, may be fast to respond (within a second or less), slow to respond (over 1 minute or more), may return large responses (>50 KB or the like) or small responses (<256 bytes or the like). These data sources 136 are preferably conventional sources such as web services, but could also include data acquired from other sources such as, but not limited to, social media, wearable devices and synthesized data sources.

The data collector 118 also assists to develop a data schema that can represent external events for use by game clients 104. These would include an event or state, logged at a specific time, with information about the source of the event or state such as was it observed, predicted, historical, or synthesized? The data collector 118 may also transform and/or normalize the data received from the data sources into a general data format for storage in the data store 122. In some embodiments, the data collector 118 may assist in developing or may include a data source directory that determines which data sources to use for a given data type request and manages redundancy and diversity of data. The data sources include the external data sources 136 outlined above or internal historical data in the data store 122 or synthesized sources. The data source directory 134 preferably describes properties of the data sources (both external and internal to the system 100) that the data collector 118 may take into account. These may include, but are not limited to, rate limit, availability, geolocation coverage, quality and the like. It is preferred that the data collection is defined by a data driven flexible system.

The data collector 118 also performs the function of responding to scheduled requests or requests that are transmitted via the data services bus 120. In general, the data collector 118 is intended to be configured with a flexible architecture such that new and diverse data sources can be handled easily.

With respect to the data service bus 120, it may be implemented in the same language that is used to implement the data engine (or server platform). In operation, the data service bus 120 connects the request handler 116, data store 122 and the data collector 118. The data service bus 120 also mediates between components of the system 100 that have different scaling requirements. For example, at peak usage times, the client facing (or request handler) side may be subject to 3000 requests per second with each request and response being in the order of 200 bytes each. The data collector side may be sending 1500 requests per second, in the region of 200 bytes each, and will be receiving the same number of responses in the order of 50 kb each to and from the data sources 136.

The request handler 116 handles requests coming from game clients 104 and then follows rules that are predetermined or pre-defined about how requests are to be handled by the data engine. Assuming three games that are live at any given moment, this may generate 3000 requests per second at peak. The request handler also generates a query for the data store 122 or creates a request for the data collector 118 to fulfil based on a request from a game client 104. The output transformation layer 126 transforms the cached data to provide requested data in the client requested format. In one embodiment, the request handler 116 includes a specific rule engine (or request handling rules apparatus) for retrieving data from the data store 122 including fuzzy requests.

An example of a fuzzy request would be: what's the most recent observation of weather conditions within 10 km of a geographical location? If this data is not available, the search may be expanded to within 30 km of the geographical location. If that is not available, the forecast from a previous day may be used.

The system may further include a personal data collector framework that collects personal data from the device associated with the game client 104. This personal data is preferably collected subject to availability, permissions and platform capabilities. Such personal data may include, but is not limited to, location, battery charge level, ambient light and motion from gyros or accelerometers. Other personal data may be data that is derived from actual gameplay. This personal data may be used as part of the data request from the game client 104. The personal data collector framework may also send personal data to the data collector 118 for integration into the data store 122 and support integration with an end user game.

With respect to the data sources 136, in a preferred embodiment, each of the data sources 136 includes an interface with the data collector 118 to load data. The data sources 136 also deliver data (synthesized or not) to the data collector 118 on request or as a part of a programming interface. The data sources 136 may also investigate algorithmic approaches to analyzing real world data sources in order to model them. Furthermore, in another embodiment, the data sources 136 may emulate behaviour of real world data sources. For example, a data source 136 may use weather forecast or historical weather data to create synthesized data in A format such as that which may be reported by a weather organization or weather website. The data source 136 may also artificially rate limit the availability of responses based on the rate limit of a weather website.

With respect to the data store 122, the database architecture and engine may be determined based on various requirements. For example, it may be useful if the database support 6000 reads and 3000 writes per second at peak times. In some embodiments, writes will be up to 50 kB of data each while reads will be in the order of 512 bytes each. The data store may be required to handle data traffic up to 10TB per day during peak activity. In operation, the data store 122 may act as intermediate storage between the data collector 118 and the request handler 116. Storage requirements may also be determined based on use cases established for client integration prototypes.

In order to implement aspects of the system, the game backend 102 supports the data engine 114. To this end, the game backend 102 includes a reusable API 110 that runs, or executes, on the game backend 102 that provides an interface between the game clients 104 and the data engine 114. Furthermore, the API 110 also provides an interface between the data engine 114 and game specific server-side code that runs on the game backend 102. The purpose of this is to allow game specific code running on the game backend 102 to interact directly with player specific game data that's stored on the game backend 102. The API 110 can also be used to resolve playable data events that occur while players are offline. For example, the API 110 can be used to find events that would have affected that player so that specific game code can use this data to update the player's game world.

In implementing client integration prototypes, a set of at least three (3) typical use cases, of real world data in games, including an initial weather-based project were determined. The use cases would be expected to consume combinations of slowly changing data (example: weather), rapidly changing data (example Twitter), sparsely available data (example: urban traffic density), data requiring multiple sources for coverage (example: live lightning strikes). These hypothetical use cases were prototyped into lightweight game clients. The prototypes may also provide integration methods with the game backend 102 and the game clients 104.

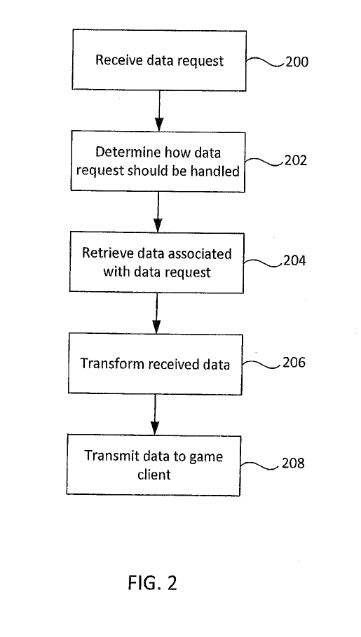

Turning to FIG. 2, a flowchart outlining a method of data engine operation according to an embodiment herein is shown. The data engine 114 receives a data request (200) from one of the game clients 104 via the game backend 102. The request handler 116 then determines (202) how the data request should be handled. The request handler may review a set of request handling rules or the request handling rules apparatus 124 may determine how the data request should be handled. Data is then retrieved (204) which complies with the data request. The data may be retrieved either via the data store 122 or via communication between the data collector 118 and at least one of the data sources 136. In another embodiment, the data may also be synthesized based on already available data. The retrieved data is then transformed (206) into a format that is usable by the game client requesting the data. In some cases, the retrieved data may already be in a compatible format such that no transformation is required. The data is then transmitted (208) to the game client.

It is noted that, in embodiments of the system and method herein, the objective is to provide “playable data” in a cross-platform environment (including mobile devices, augmented reality/virtual reality (AR/VR) devices and the like). The delivery of real world data to the game environment is not limited to simulating the real world environment in the game environment but can be used based on game designer requirements or desires. For example, real world weather conditions may be abstracted in various ways such as turning types of weather or characteristics of weather (amount of rainwater) into different types of gems for trading or the like. Furthermore, embodiments of the system and method herein may alternatively use the occurrence of weather (i.e. rain) to unlock doors, melt zombies or impact other aspects of the game environment. The data provided by the data engine may be used in any way by the game client and is not dictated by the data engine. The current embodiments are intended to provide a system and method that provides an ongoing flow of real data from a variety of sources to use either directly or in the abstract to power a broad base of game types and playable events within the game.

As noted above, the system is preferably scalable and flexible to respond to unexpected demands for data on the system. The scaling requirements of the system may require that the system be operable on and/or migrated to other platforms or solutions.

In order to maintain a more efficient system, data caching may be used. In order to improve data caching, reviews and iterations on how the data is used, stored, and retrieved, in order to efficiently re-use the data may be regularly performed.

Although currently described in a basic manner, it is understood that the data service bus may be or become more complex as the impact of scaling increases. Also, real world data might not directly meet the needs of game clients, which could mean that increased processing of the retrieved data may be required to make it useful. For example, real world sources may not be as accurate as required, may not be available enough to provide real-time coverage, even with multiple sources, or may not provide the necessary granularity. As such, and as noted above, the system and method may also be configured to simulate or synthesize data to address these issues.

In the preceding description, for purposes of explanation, numerous details are set forth in order to provide a thorough understanding of the embodiments. However, it will be apparent to one skilled in the art that these specific details may not be required in order to practice the invention. In some instances, well-known structures may be shown in block diagram form in order not to obscure the invention. For example, specific details are not provided as to whether the embodiments of the invention described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed by a processor, cause the processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

Various embodiments are described herein. Variations of those embodiments may become apparent to those of ordinary skill in the art upon reading the foregoing description. It is expected that skilled persons will employ such variations as appropriate, and it is expected that the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Further variations may be apparent or become apparent to those knowledgeable in the field, and are within the scope as defined by the claims.

1. A system for data integration for a virtual environment comprising:
a game backend;
a plurality of game clients, wherein each of the game clients comprise a client engine which is connected to the game backend;
a plurality of data sources; and
a data engine connected with the game backend and with the plurality of data sources, wherein the data engine retrieves data from the data sources and provides it to the game backend for use by the plurality of game clients, via the client engine.

2. A system according to claim 1, wherein the data engine comprises a data collector for retrieving the data from the data sources and a request handler for handling data requests from the game backend.

3. A method for data integration for a virtual environment comprising:
receiving, at a data engine, a data request from a game client via a game backend;
retrieving data from a data source that complies with the data request or, if data is not available from the data source, synthesizing data;
transforming the retrieved data into a format that is usable by the game client requesting the data;
transmitting the data to the game client via the game backend.

4. A system and method for data integration for a virtual environment as both generally and specifically described herein.
